(19) United States
(12) Patent Application Publication
(10) Pub. No.: US 2015/0134442 A1
(43) Pub. Date: May 14, 2015

(54) BEST MONETARY DISCOUNT DETERMINATION METHODS AND SYSTEMS

(71) Applicant: TARGET BRANDS INC., Minneapolis, MN (US)

(72) Inventor: Saurabh Shekhar, Bangalore (IN)

(21) Appl. No.: 14/527,904

(22) Filed: Oct. 30, 2014

Related U.S. Application Data
(60) Provisional application No. 61/904,126, filed on Nov. 14, 2013.

(51) Int. Cl. G06Q 30/02

(52) U.S. Cl. CPC G06Q 30/0239
USPC 705/14.39

(57) ABSTRACT

Methods and systems are described that determine the promotion(s) offering the best monetary discount available to a customer. The methods and systems can be used at the time of checkout during a retail purchase or prior to checkout to inform the customer about the best deal that may be available based on alternative proposed purchases. One method can include defining a promotion combinability matrix that identifies combination logic of the available promotions. In addition, a priority set of the available promotions is established that identifies the priority in which the promotions will be applied. The promotion combinability matrix and the priority set are then used to determine the best monetary discount that is available to the customer.

### BACKGROUND

Sales promotion is an important tool in retail commerce to drive sales. Sales promotions are utilized to increase consumer demand, stimulate market demand or improve product availability. Examples of sales promotions include contests, coupons, freebies, loss leaders, point of purchase displays, premiums, prizes, product samples, and rebates.

Often times, multiple promotions may be simultaneously available to a customer. In these cases, efforts are made to present the customer with the best deal in view of all of the available promotions.

One technique that is currently employed to determine the best deal available when multiple promotions apply is to apply “FOR” loop logic in a promotion calculation engine that checks all of the possible combinations of the promotions that are available to the customer to determine the best deal. In a simple example, if there are 5 promotions that are available at checkout, the promotion engine will be called 5! (i.e. 120) times in order to determine the best deal out of the 120 possible combinations of promotions. More complex scenarios can involve a larger number of promotions and/or multiple promotions having different priorities that determine the order in which the promotions are to be applied, exponentially increasing the number of possible combinations. Since each possible combination is checked, this known technique is slow which adds delay to the checkout process.

### SUMMARY

Methods and systems are described that determine the promotion(s) offering the best monetary deal or discount to a customer. The methods and systems described herein can, for example, be used in the field of sales promotion for retailers in retail stores and on websites. The described methods and systems determine from among a plurality of possible promotions the best monetary discount available to a customer, for example prior to or at the time of checkout. When utilized at the time of checkout during a retail purchase, the described methods and systems can result in a faster determination of the best deal for the customer thereby reducing checkout delay. The described methods and systems could also be utilized prior to checkout to inform the customer about the best deal that may be available based on alternative proposed purchases.

As used herein, the language “best monetary deal or discount” includes, but is not limited to, the lowest actual purchase price available to the customer, the largest value amount of free gifts, free services, and the like that are available to the customer based on their purchase, the largest amount of future discounts that are available to the customer based on their current purchase, and the like.

The described methods and systems can be utilized in a retail setting, for example at the time the customer is checking out. Checkout can be in a checkout line in a retail store or an on-line checkout on a store's website that is available on the Internet through which the customer is making a purchase.

In one embodiment, a method of determining the best monetary discount available to a customer based on a plurality of available promotions includes defining a promotion combinability matrix that identifies a combination logic of the plurality of promotions. In addition, a priority set of the plurality of promotions is identified and stored in non-transitory memory that identifies the priority in which the promotions will be applied. The promotion combinability matrix and the priority set are then used to determine the best monetary discount that is available to the customer, and the best monetary discount is displayed to the customer.

In another embodiment, a system that is configured to determine the best monetary discount available to a customer includes a server that includes a promotion combinability matrix module having stored in memory a promotion combinability matrix providing combination logic of a plurality of available promotions. The server also includes a priority set module that has stored in memory a priority set that identifies the priority in which the promotions will be applied to the purchase. The server also includes a determination module that is in communication with the promotion combinability matrix module and the priority set module, and that determines the best monetary discount that is available to the customer. The modules of the system can be implemented in software, firmware, hardware, or combinations thereof.

In one embodiment, the server is part of a computing system that includes one or more processors that can be used to, for example, determine the best monetary discount; one or more non-transitory computer-readable tangible storage devices that can be used to store the promotion combinability matrix and the priority set; a display device; a user input device; and program instructions stored on at least one of the one or more non-transitory computer-readable tangible storage devices for executing the steps in determining the best monetary discount.

In another embodiment, the method can be implemented via a computer program product that includes one or more non-transitory computer-readable tangible storage devices, and program instructions stored on at least one of the one or more computer-readable tangible storage devices which, when executed, determine the best monetary discount.

### DRAWINGS

FIG. 1 illustrates an example method for use in determining the best monetary discount available to a customer.

FIG. 2 illustrates an example system that is configured to determine the best monetary discount available to a customer.

FIG. 3 illustrates an example process of determining the best monetary discount.

FIG. 4 illustrates an example website screenshot that a customer may see displaying the results of specific scenario 1.

FIG. 5 illustrates an example website screenshot that a customer may see displaying the results of specific scenario 2.

FIG. 6 illustrates an example of a promotion combinability matrix.

FIG. 7 is a schematic diagram for an architecture for a computing device that can be used to implement the methods and systems described herein.

### DETAILED DESCRIPTION

Methods and systems are described herein that present a customer with the promotion(s) offering the best monetary deal or discount with respect to a purchase. The methods and systems can be utilized in a retail setting at the time the customer is checking out, or utilized prior to checkout, for example to inform the customer about the best deal that may be available based on one or more proposed purchases the customer may have interest in making. Checkout can be in a checkout line in a retail store or an on-line checkout on a store's website that is available on the Internet. However, the described methods and systems are not limited to a determination made at the time of checkout.

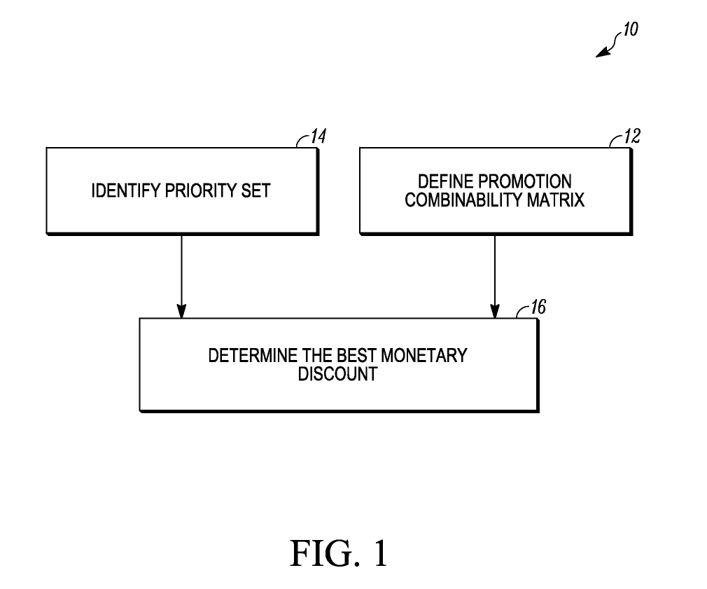

With reference initially to FIG. 1, one embodiment of a method 10 is illustrated. In this embodiment, a promotion combinability matrix is defined 12. The matrix identifies combination logic to be used that identifies the possible combinations of the plurality of promotions when there are a plurality of promotion types that are available based upon the item(s) the customer is, or has an interest in, purchasing. In addition, a priority set is identified 14 for the plurality of promotions that may be applicable. Once the promotion combinability matrix and the priority set are established, they are then used to determine 16 the best monetary discount that is available to the customer.

Examples of promotions that can be offered and included in the priority set can include, but are not limited to, fixed price promotions (for example, get 3 DVDs at $10, while 1 DVD is priced at $5), percentage off promotions (for example, a defined percent off on an item or off an entire purchase e.g. the entire cart), dollar off promotions (for example, a defined dollar amount off on certain items or the entire purchase), free gift or service promotions (for example, a free gift/service is obtained based on purchase of an item(s) or based on total purchase amount), future discount promotion (for example, a defined percent or dollar amount off on a future purchase), and the like. Many other promotions are known and available, and are considered to be encompassed by the methods and systems described herein.

The promotions are also ranked in order of desired priority to form the priority set. For example, in one embodiment, a priority set can be established where free gift promotions are ranked highest priority, followed by fixed price promotions, followed by percentage off promotions, followed by dollar off promotions, etc. However, this promotion ranking is an example only and other rankings are possible.

In addition, categories or types of promotions are defined which are used to define the promotion combinability matrix. The categories allow multiple promotions to be stacked-up on one another, i.e. applied, for the same item/product/category. For example, to help describe the systems and methods herein, four example categories of promotions can be established as follows:
Sitewide (S)—A sitewide promotion is a promotion that can be combined with any other promotion type; and an S promotion is available to anyone who meets qualifications;
Unrestricted (U)—An unrestricted promotion is a promotion that can be combined with S promotions, other U promotions, and Preferential promotions; a U promotion can be combined with multiple U promotions or one Preferential promotion;
Preferential (P)—A preferential promotion is a promotion that can be combined with S and U promotions; a P promotion is combinable with any number of U promotions; if multiple P promotions are available, customer will get the best available P promotion; and
Exclusive (E)—An exclusive promotion is a promotion that can be combined only with S promotions; if multiple E promotions are available, the customer will get the best available E promotion.
   These promotion categories are examples only, and other promotion categories are possible and can be established.

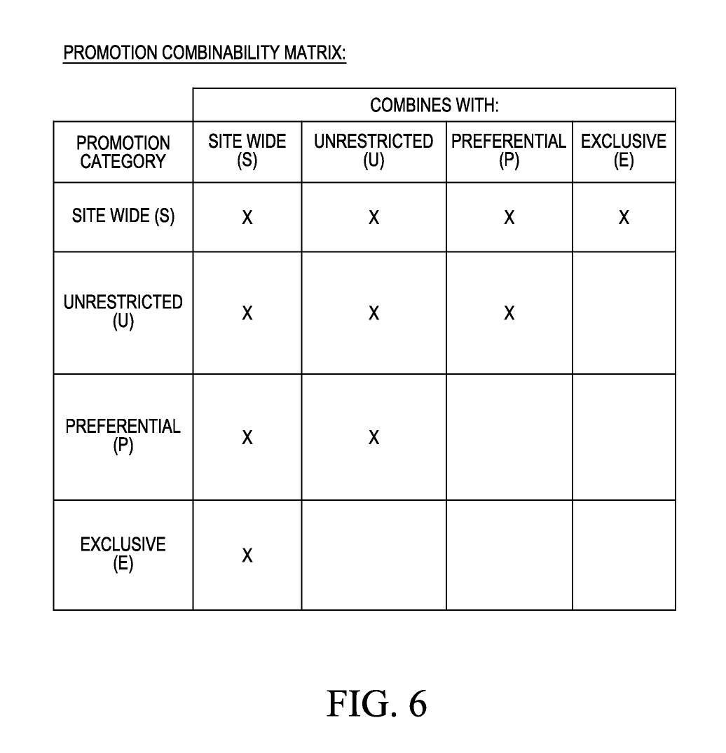

Once the promotion categories are established, the promotion combinability matrix is generated. An example of a promotion combinability matrix using the four categories Sitewide, Unrestricted, Preferential and Exclusive discussed above is illustrated in FIG. 6.

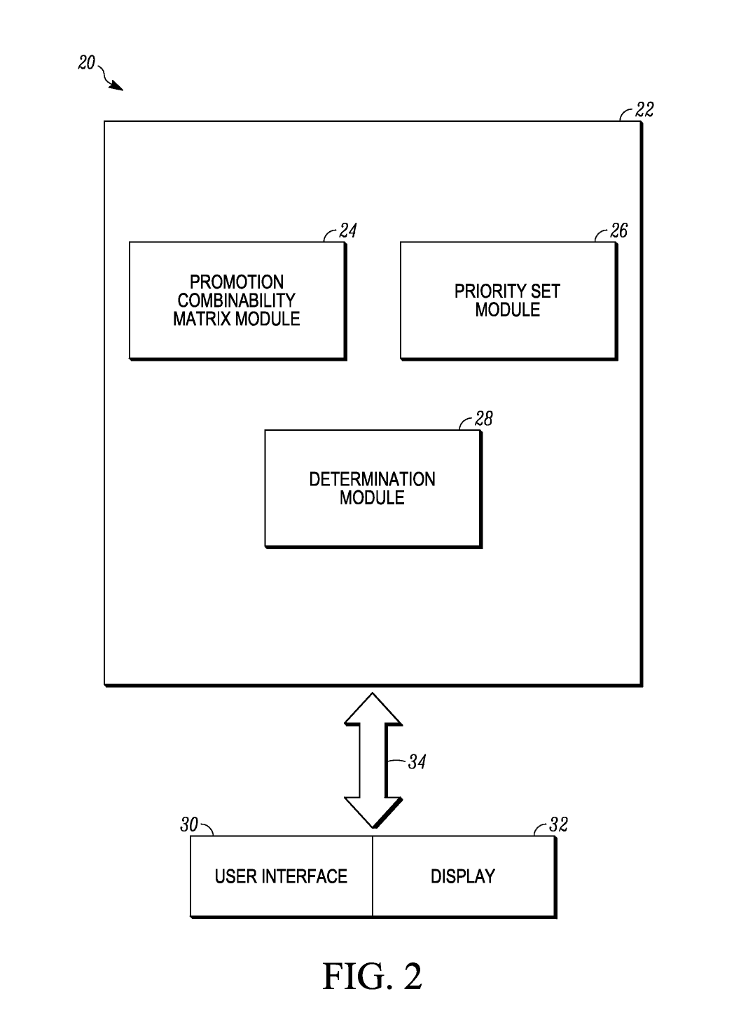

With reference to FIG. 2, an example system 20 is illustrated that is configured to implement the method 10 to determine the best monetary discount for a customer. The system 20 includes a server 22 or other computing system that performs the calculations described herein to determine the best monetary discount. As would be understood, the server 22 includes one or more processors that perform the necessary calculations and other processing and functions, along with one or more non-transitory computer-readable tangible storage devices or memory.

The server 22 includes a promotion combinability matrix module 24 having stored in memory, for example one of the non-transitory computer-readable tangible storage devices, the promotion combinability matrix. The promotion combinability matrix module 24 uses the information on the promotion categories and generates the promotion combinability matrix. The promotion categories can change so the module 24 can store different matrixes and generate new matrixes as different promotion categories and different combinations of promotion categories are generated.

The server also includes a priority set module 26 that has stored in memory, for example one of the non-transitory computer-readable tangible storage devices, a priority set that identifies the priority in which the promotions will be applied to the purchase. The module 26 is provided with the promotions that are available, for example fixed price promotions, percentage off promotions, dollar off promotions, free gift promotions, etc., and generates the priority set(s). More than one priority set can be generated by the module 26 based on the desired priority of the available promotions.

The server also includes a determination module 28 that is in communication with the promotion combinability matrix module 24 and the priority set module 26, and that determines the best monetary discount that is available to the customer using a methodology described further below.

The modules 24, 26, 28 can be implemented in software, firmware, hardware, or combinations thereof, necessary to perform the functions of the modules 24, 26, 28.

The system 20 also includes a user interface 30 and a display 32 that can interface 34 with the server 22 in a suitable manner, for example via a local area network, or a proprietary or non-proprietary wide area network such as the Internet.

The user interface 30 can be, for example, a personal computer, a cash register in a retail store, or a personal device such as a smart phone or tablet computer. The user interface 30 allows the input of purchase information of the customer. For example, in a retail store based implementation, the user interface 30 can be a cash register in which an item to be purchased is manually entered or entered via a scanner. In a web-based implementation, the user interface 30 can be a customer's personal computer, smart phone or tablet that accesses a website through which an item(s) to be purchased is selected and possibly stored in a cart until ready for checkout in a known manner. The display 32 can be a monitor of a personal computer, a cash register display, the screen of a smart phone or a tablet, or any other display that allows a user to view information relating to the purchase, for example the item(s) being purchased and/or price of the item(s), as well as display the resulting discounted price and optionally the amount of the discount received and information on the discounts that were applied.

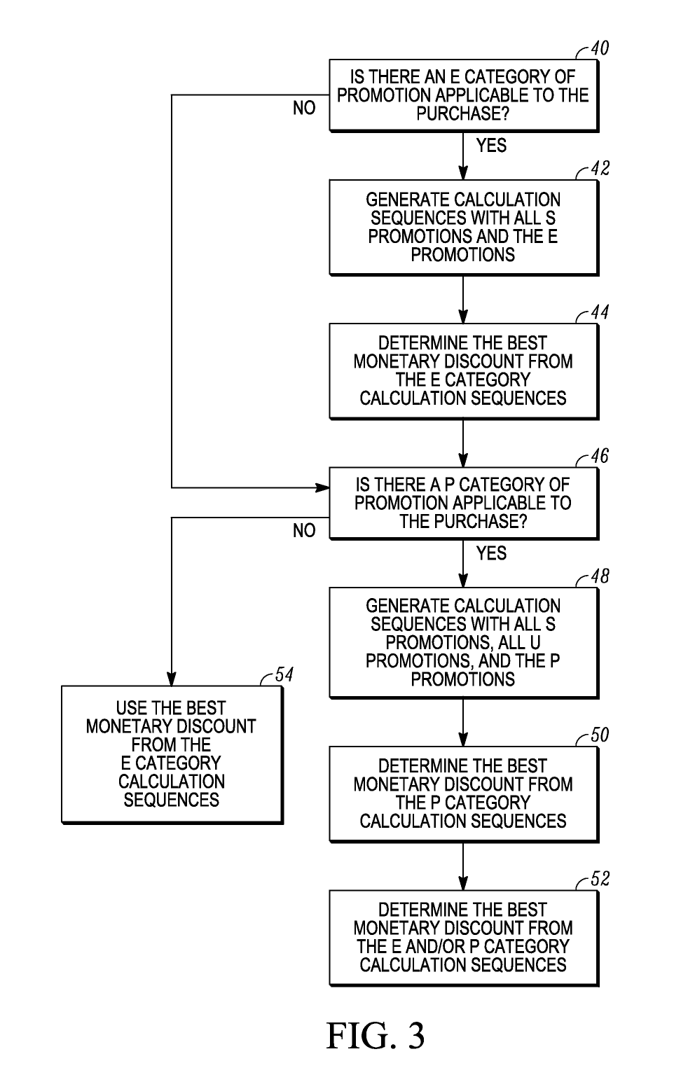

In one embodiment, with reference to FIG. 3, the determination module 28 can determine the best monetary discount in the following manner. In this embodiment, it is assumed that the available promotions are prioritized in the priority set in the following order: Free Gift>Fixed Price>% Off>$ Off as provided by the priority set module 26.

At 40, the determination module 28 checks if, among all the promotions of the same priority, there is an E category of promotions that is available. If yes, then calculation sequences are generated with all S promotions and the E promotion(s) at 42. The best monetary discount from the calculation sequences is then determined at 44. Alternatively, rather than generating all calculation sequences at 42, the best available E promotion can be determined and used in a calculation sequence with all S promotions. The best E promotion can be determined based on the type of promotion it is, i.e. Free Gift>Fixed Price>% Off>$ Off, and its place in the priority set. The best monetary discount resulting from 44 can then be stored as a variable X.

If there is not an E category of promotion at 40, then the process executed by the determination module 28 skips 42 and 44 and proceeds to 46. At 46, the determination module 28 performs a check to determine if, among all the promotions of the same priority, there is a P category of promotion that is available. If yes, then calculation sequences are generated using all S promotions, all U promotions, and the P promotion(s) at 48. The best monetary discount from the calculation sequences is then determined at 50. Alternatively, rather than generating all calculation sequences at 48, the best available P promotion can be determined and used in a calculation sequence with all S and U promotions. The best P promotion can be determined in the same manner as the best E promotion. Once the best monetary discount at 50 is identified, it can be stored as a variable Y. At 52, the module 28 then compares variable X (if present) and variable Y, and determines the best discount which is then provided to the customer. If the result at 46 is no, at 54 the module 28 will apply the best monetary discount determined at 44.

The disclosed methods and systems move away from the brute force method of checking for all permutations and combinations of promotions with the same priority, and instead rely on a derived logic of reducing the number of checks using mathematics and a logic matrix. To help illustrate, consider a case where there are 3S, 3U, 2P and 2E promotions of the same priority that are available to a customer. In the prior art technique, the calculation engine will be called (3+3+2+2)! times, i.e. 10!=3628800 times in order to determine the best deal available. In contrast, with the described logic, a calculation engine of the determination module will be called as follows: 1) all S promotions and E₁; 2) all S promotions and E₂; 3) all S promotions, all U promotions and P₁; and 4) all S promotions, all U promotions and P₂, for a total of 4 calculations in order to determine the best deal available. So data processing demands are reduced and the discount results are presented to the customer faster.

### Example Approach 1

The following is an example illustrating a determination of a best monetary deal that is available to a customer at the time of checkout. In this example, the customer's cart includes one item with a list price of $1018.00.

In this example, “fixed” refers to a fixed price promotion; “% off” refers to a percentage off promotion; and “$ off” refers to a dollar off promotion. In addition, for purposes of this example, the promotions are prioritized in the following order: a free gift promotion has priority over a fixed price promotion which in turn has priority over a percentage off promotion which in turn has priority over a dollar off promotion. In addition, it is assumed that the S, U, P, and E promotion types discussed above are available.

In this example, the one item is eligible for 2 Sitewide promotions (Sitewide fixed, Sitewide % off), 2 Unrestricted promotions (Unrestricted % off, Unrestricted $ off) and 2 Preferential promotions (Preferential $ off, Preferential Fixed).

Considering all the eligible promotions and prioritized, the following sequence is generated.
P Fixed, S Fixed, U % off, S % off, P $ off, U $ off

| Determination Steps | | Calculation sequences |
|---|---|---|
| 1. | Since there are no E promotions, | 1. S Fixed, P Fixed, U % |
| | the determination proceeds to | off, S % off, U $ off |
| | checking for P promotions. The P | |
| | promotions are grouped and | |
| | prioritized as follows: | |
| | P Fixed, P $ off | |
| 2. | Based on the priority of the P | |
| | promotion, P Fixed is inserted into | |
| | the other promotion list (S Fixed, | |
| | U % off, S % off, U $off) to | |
| | generate calculation sequence 1 | |

| | |
|---|---|
| The above step 2 is repeated for the P $ off | 2. S Fixed, U % off, |
| to generate calculation sequence 2 | S % off, U $ off, P $ off |

Specific Scenario 1:

Assume the following are example eligible promotions all having the same priority, and assume the list price of $1018.00 and the priority set sequence in the example approach above.

| Promotion Name | Priority | Exclusiveness | Details |
|---|---|---|---|
| P1 | 1000 | Site wide (S) | 25$ off |
| P2 | 1000 | Site wide (S) | Fixed price 400 |
| P3 | 1000 | Site wide (S) | 5% off |
| P4 | 1000 | Unrestricted (U) | 10$ off |
| P5 | 1000 | Preferential (P) | Fixed price 300 |
| P6 | 1000 | Preferential (P) | 2% off |
| Best Price | 250 | | |

With these example eligible promotions, the following calculation sequences are generated to determine the best monetary discount.

| Sequence | Monetary Discount |
|---|---|
| 1) P Fixed, S Fixed, S % off, U $ off, S $ off | 250 |
| 2) S Fixed, P % off, S % off, U $ off, S $ off | 337.4 |

Note: In this example, only one promotion among P5 and P6 in any calculation sequence will be applied since Preferential (P6) cannot combine with another Preferential (P5).

It is seen that in Specific Scenario 1, for sequence 1, the total price of the one item with the promotions applied would be $250. For sequence 2, the total price of the item with the promotions applied would be $337.40. Therefore, the best monetary discount is for sequence 1, and the customer price for the one item would be $250 which is a discount of $768 or 73% from the original list price of $1018.00.

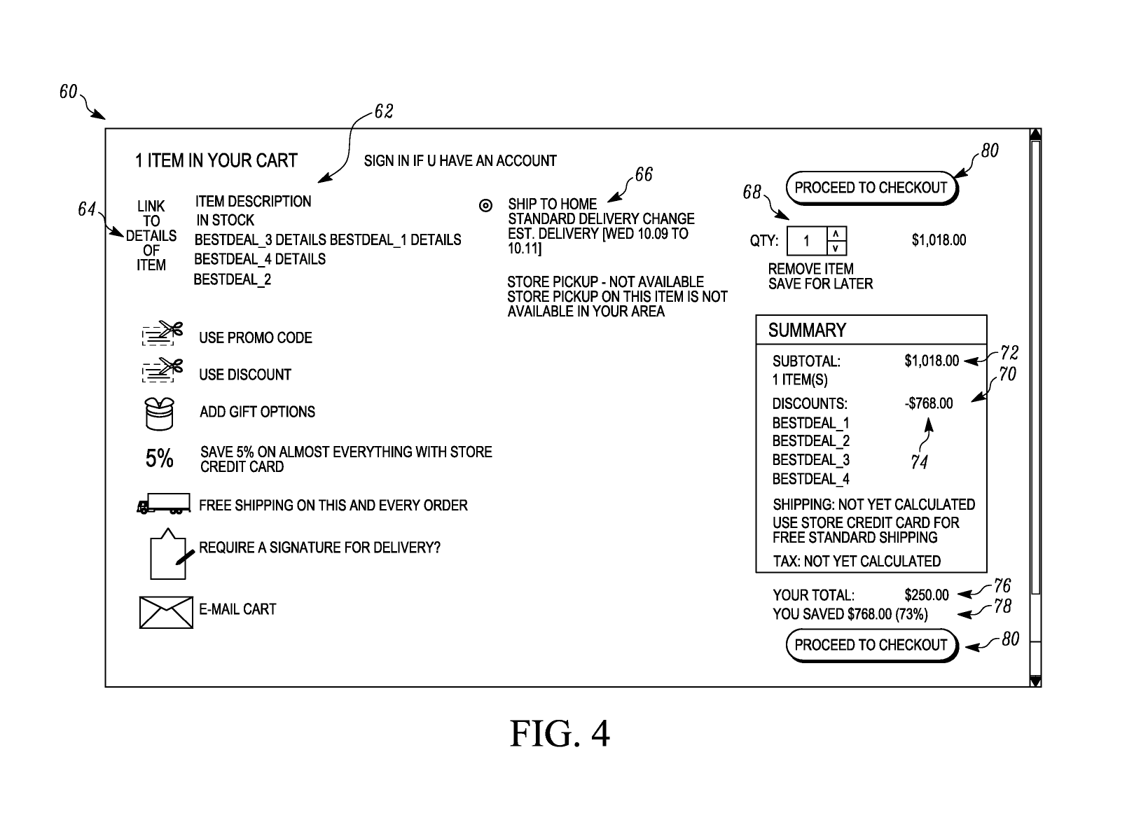

FIG. 4 illustrates an example screenshot of a website page 60 that could be displayed to the customer on a display (e.g. display 32 of FIG. 2) of her personal computer, laptop, tablet, mobile phone, or the like displaying the results of Specific Scenario 1. The page 60 can include a description of the item(s) 62 the customer has placed into her virtual shopping cart, one or more links 64 that can be selected by the customer that takes the customer to more detailed information on the item(s) 62 in her cart, shipping information 66, item quantity 68 information, a summary section 70 that lists a subtotal price 72 of the item(s) in the cart, the best monetary discount 74 applicable to that purchase, a total price 76 after the discount 74 is applied to the subtotal price 72, and an explanation 78 of the savings realized by the customer, for example listing a total dollar amount saved and/or listing a percentage saved. If the customer wishes to proceed with the purchase, the customer can select a “proceed to checkout” button 80.

Specific Scenario 2:

Assuming the same above that there is only one item in the cart, the list price of the item is $1018, and the priority set sequence is as in the example approach above.

Assuming the following are the eligible promotions.

| Promotion Name | Priority | Exclusiveness | Details |
|---|---|---|---|
| P1 | 1000 | Site wide | 25$ off |
| P2 | 1000 | Site wide | 2% off |
| P3 | 1000 | Site wide | 5% off |
| P4 | 1000 | Unrestricted | 10$ off |
| P5 | 1000 | Preferential | Fixed price 900 |
| P6 | 1000 | Preferential | 150$ off |
| Cart Price | 762.76 | | |

With these example eligible promotions, the following calculation sequences are generated to determine the best monetary discount.

| Sequence | Monetary discount |
|---|---|
| 1) P Fixed, S % off, S % off, U $ off, S $ off | 802.9 |
| 2) S % off, S % off, U $ off, S $ off, P $ off | 762.76 |

It is seen that in Specific Scenario 2, for sequence 1, the total price of the one item with the promotions applied would be $802.9. For sequence 2, the total price of the item with the promotions applied would be $762.76. Therefore, the best monetary discount is for sequence 2, and the customer price for the one item would be $762.76 which is a discount of $255.34 or 24% from the original list price of $1018.00.

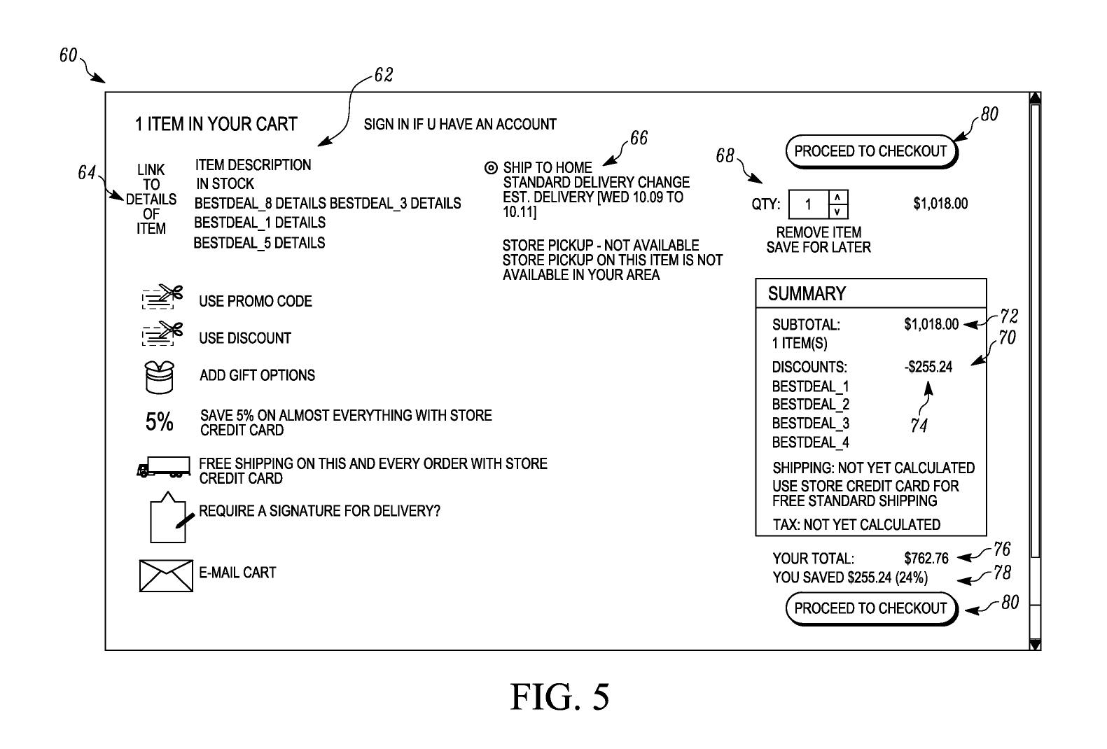

FIG. 5 illustrates an example screenshot of the website page 60 that could be displayed to the customer on a display (e.g. display 32 of FIG. 2) of her personal computer, laptop, tablet, mobile phone, or the like displaying the results of Specific Scenario 2. The page 60 is similar to the page 60 in FIG. 4 and like elements are referenced using the same reference numbers. The page 60 can include a description of the item(s) 62 the customer has placed into her virtual shopping cart, one or more links 64 that can be selected by the customer that takes the customer to more detailed information on the item(s) 62 in her cart, shipping information 66, item quantity 68 information, a summary section 70 that lists a subtotal price 72 of the item(s) in the cart, the best monetary discount 74 applicable to that purchase, a total price 76 after the discount 74 is applied to the subtotal price 72, and an explanation 78 of the savings realized by the customer, for example listing a total dollar amount saved and/or listing a percentage saved. If the customer wishes to proceed with the purchase, the customer can select a “proceed to checkout” button 80.

### Example Approach 2

The following is another example illustrating a determination of a best monetary deal that is available to a customer at the time of checkout. In this example, the customer's cart again includes one or more items with a list price of $1018.00.

In this example, “fixed” refers to a fixed price promotion; “% off” refers to a percentage off promotion; and “$ off” refers to a dollar off promotion. In addition, for purposes of this example, the promotions are prioritized in the following order: a free gift promotion has priority over a fixed price promotion which in turn has priority over a percentage off promotion which in turn has priority over a dollar off promotion. In addition, it is assumed that the S, U, P, and E promotion types discussed above are available.

In this example, the item(s) in the cart is eligible for 2 Sitewide (Sitewide fixed, Sitewide % off), 2 Unrestricted (Unrestricted % off, Unrestricted $ off), 2 Preferential (Preferential $ off, Preferential Fixed) and 2 Exclusive (Exclusive % off and Exclusive $ off) promotions.

Considering all the eligible promotions and priorities, the following sequences are generated.

| Considering all the | |
|---|---|
| eligible promotions | P Fixed, S Fixed, U % off, S % off, |
| and priorities. | P $ off, U $ off, E % off, E $ off |
| 1. Checking for E promotions to | S Fixed, S % off, E % off |
| identify possible sequences | S Fixed, S % off, E $ off |
| 2. Checking for P promotions to | S Fixed, P Fixed, U % off, S % |
| identify possible sequences | off, U $ off |
| | S Fixed, U % off, S % off, U $ |
| | off, P $ off |

Specific Scenario 3:

Assume the following are example eligible promotions all having the same priority, assume a single item in the cart at the list price of $1018.00 and the priority set sequence in the example approach above.

| Promotion Name | Priority | Exclusiveness | Details |
|---|---|---|---|
| P1 | 1000 | Site wide | 25$ off |
| P2 | 1000 | Site wide | Fixed price 400 |
| P3 | 1000 | Site wide | 5% off |
| P4 | 1000 | Unrestricted | 10$ off |
| P5 | 1000 | Preferential | Fixed price 300 |
| P6 | 1000 | Preferential | 2% off |
| P7 | 1000 | Exclusive | 5% off |
| P8 | 1000 | Exclusive | 20$ off |
| Cart Price | 250 | | |

With these example eligible promotions, the following calculation sequences are generated to determine the best monetary discount.

| Sequence | Monetary Discount |
|---|---|
| 1) S Fixed, S % off, E % off | 361 |
| 2) S Fixed, S % off, E $ off | 360 |
| 3) P Fixed, S Fixed, S % off, U $ off, S $ | 250 |
| off | |
| 4) S Fixed, P % off, S % off, U $ off, S $ | 337.4 |
| off | |

It is seen that in Specific Scenario 3, the best monetary discount is for sequence 3, and the customer price would be $250.

Specific Scenario 4:

Assume the same as above that there is only one item in the cart and the list price of the item is $1018 and the priority set sequence is as in the example approach above.

Assume the following are the eligible promotions.

| Promotion Name | Priority | Exclusiveness | Details |
|---|---|---|---|
| P1 | 1000 | Site wide | 25$ off |
| P2 | 1000 | Site wide | 2% off |
| P3 | 1000 | Site wide | 5% off |
| P4 | 1000 | Unrestricted | 10$ off |
| P5 | 1000 | Preferential | Fixed price 900 |
| P6 | 1000 | Preferential | 150$ off |
| P7 | 1000 | Exclusive | 7% off |
| P8 | 1000 | Exclusive | 50$ off |
| Cart Price | 762.76 | | |

With these example eligible promotions, the following calculation sequences are generated to determine the best monetary discount.

| Sequence | Monetary Discount |
|---|---|
| 1) S % off, S % off, E % off, S $ off | 856.41 |
| 2) S % off, S % off, S $ off, E $ off | 897.76 |
| 3) P Fixed, S % off, S % off, U $ off, S $ | 802.9 |
| off | |
| 4) S % off, S % off, U $ off, S $ off, P $ | 762.76 |
| off | |

It is seen that in Specific Scenario 4, the best monetary discount is for sequence 4, and the customer price would be $762.76.

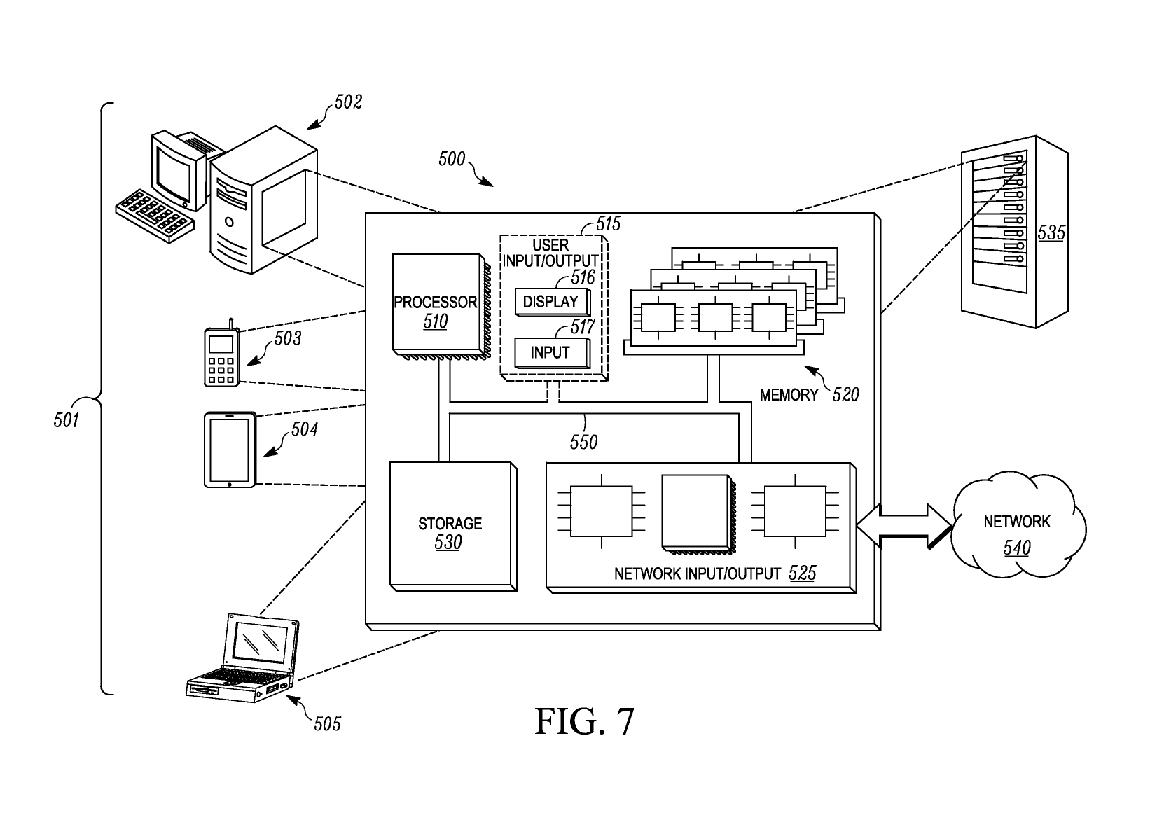

FIG. 7 is a schematic diagram of an example architecture for a computer device 500. The computer device 500 and any of the individual components thereof can be used for any of the operations described in accordance with any of the computer-implemented methods described herein.

The computer device 500 generally includes a processor 510, memory 520, a network input/output (I/O) 525, storage 530, and an interconnect 550. The computer device 500 can optionally include a user I/O 515, according to some embodiments. The computer device 500 can be in communication with one or more additional computer devices 500 through a network 540.

The computer device 500 is generally representative of hardware aspects of a variety of user devices 501 and a server device 535. The illustrated user devices 501 are examples and are not intended to be limiting. Examples of the user devices 501 include, but are not limited to, a desktop computer 502, a cellular/mobile phone 503, a tablet device 504, and a laptop computer 505. It is to be appreciated that the user devices 501 can include other devices such as, but not limited to, a personal digital assistant (PDA), a video game console, a television, or the like. In some embodiments, the user devices 501 can alternatively be referred to as client devices 501. In such embodiments, the client devices 501 can be in communication with the server device 535 through the network 540. One or more of the client devices 501 can be in communication with another of the client devices 501 through the network 540 in some embodiments.

The processor 510 can retrieve and execute programming instructions stored in the memory 520 and/or the storage 530. The processor 510 can also store and retrieve application data residing in the memory 520. The interconnect 550 is used to transmit programming instructions and/or application data between the processor 510, the user I/O 515, the memory 520, the storage 530, and the network I/O 540. The interconnect 550 can, for example, be one or more busses or the like. The processor 510 can be a single processor, multiple processors, or a single processor having multiple processing cores. In some embodiments, the processor 510 can be a single-threaded processor. In some embodiments, the processor 510 can be a multi-threaded processor.

The user I/O 515 can include a display 516 and/or an input 517, according to some embodiments. It is to be appreciated that the user I/O 515 can be one or more devices connected in communication with the computer device 500 that are physically separate from the computer device 500. For example, the display 516 and input 517 for the desktop computer 502 can be connected in communication but be physically separate from the computer device 500. In some embodiments, the display 516 and input 517 can be physically included with the computer device 500 for the desktop computer 502. In some embodiments, the user I/O 515 can physically be part of the user device 501. For example, the cellular/mobile phone 503, the tablet device 504, and the laptop 505 include the display 516 and input 517 that are part of the computer device 500. The server device 535 generally may not include the user I/O 515. In some embodiments, the server device 535 can be connected to the display 516 and input 517.

The display 516 can include any of a variety of display devices suitable for displaying information to the user. Examples of devices suitable for the display 516 include, but are not limited to, a cathode ray tube (CRT) monitor, a liquid crystal display (LCD) monitor, a light emitting diode (LED) monitor, or the like.

The input 517 can include any of a variety of input devices or means suitable for receiving an input from the user. Examples of devices suitable for the input 517 include, but are not limited to, a keyboard, a mouse, a trackball, a button, a voice command, a proximity sensor, an ocular sensing device for determining an input based on eye movements (e.g., scrolling based on an eye movement), or the like. It is to be appreciated that combinations of the foregoing inputs 517 can be included for the user devices 501. In some embodiments the input 517 can be integrated with the display 516 such that both input and output are performed by the display 516.

The memory 520 is generally included to be representative of a random access memory such as, but not limited to, Static Random Access Memory (SRAM), Dynamic Random Access Memory (DRAM), or Flash. In some embodiments, the memory 520 can be a volatile memory. In some embodiments, the memory 520 can be a non-volatile memory. In some embodiments, at least a portion of the memory can be virtual memory.

The storage 530 is generally included to be representative of a non-volatile memory such as, but not limited to, a hard disk drive, a solid state device, removable memory cards, optical storage, flash memory devices, network attached storage (NAS), or connections to storage area network (SAN) devices, or other similar devices that may store non-volatile data. In some embodiments, the storage 530 is a computer readable medium. In some embodiments, the storage 530 can include storage that is external to the computer device 500, such as in a cloud.

The network I/O 525 is configured to transmit data via a network 540. The network 540 may alternatively be referred to as the communications network 540. Examples of the network 540 include, but are not limited to, a local area network (LAN), a wide area network (WAN), the Internet, or the like. In some embodiments, the network I/O 525 can transmit data via the network 540 through a wireless connection using WiFi, Bluetooth, or other similar wireless communication protocols. In some embodiments, the computer device 500 can transmit data via the network 540 through a cellular, 3G, 4G, or other wireless protocol. In some embodiments, the network I/O 525 can transmit data via a wire line, an optical fiber cable, or the like. It is to be appreciated that the network I/O 525 can communicate through the network 540 through suitable combinations of the preceding wired and wireless communication methods.

The server device 535 is generally representative of a computer device 500 that can, for example, respond to requests received via the network 540 to provide, for example, data for rendering a website on the user devices 501. The server 535 can be representative of a data server, an application server, an Internet server, or the like.

Aspects described herein can be embodied as a system, method, or a computer readable medium. In some embodiments, the aspects described can be implemented in hardware, software (including firmware or the like), or combinations thereof. Some aspects can be implemented in a non-transitory, tangible computer readable medium, including computer readable instructions for execution by a processor. Any combination of one or more computer readable medium(s) can be used.

The computer readable medium can include a computer readable signal medium and/or a computer readable storage medium. A computer readable storage medium can include any tangible medium capable of storing a computer program for use by a programmable processor to perform functions described herein by operating on input data and generating an output. A computer program is a set of instructions that can be used, directly or indirectly, in a computer system to perform a certain function or determine a certain result. Examples of computer readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing. A computer readable signal medium can include a propagated data signal having computer readable instructions. Examples of propagated signals include, but are not limited to, an optical propagated signal, an electro-magnetic propagated signal, or the like. A computer readable signal medium can include any computer readable medium that is not a computer readable storage medium that can propagate a computer program for use by a programmable processor to perform functions described herein by operating on input data and generating an output.

Some embodiments can be provided to an end-user through a cloud-computing infrastructure. Cloud computing generally includes the provision of scalable computing resources as a service over a network (e.g., the Internet or the like).

A computer program product described herein can include one or more non-transitory computer-readable tangible storage devices, and program instructions stored on at least one of the one or more non-transitory computer-readable tangible storage devices which, when executed, perform the following to determine the best monetary discount available to a customer based on a plurality of available promotions:

defining a promotion combinability matrix that identifies a combination logic of the plurality of promotions;

identifying a priority set of the plurality of promotions that identifies the priority in which the promotions will be applied;

using a computer processor to access the promotion combinability matrix and the priority set to determine the best monetary discount that is available to the customer; and

displaying the best monetary discount to the customer.

The described embodiment(s) may be embodied in other forms without departing from the spirit or novel characteristics thereof. The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of reducing computer processing demand when determining the best monetary discount available to a customer based on a plurality of available promotions, comprising:
defining and storing in non-transitory memory that can be accessed by a computer processor a promotion combinability matrix that identifies a combination logic of the plurality of available promotions;
identifying and storing in non-transitory memory that can be accessed by the computer processor a priority set of the plurality of available promotions that identifies the priority in which the available promotions will be applied;
using the computer processor to access the promotion combinability matrix and the priority set to determine the best monetary discount that is available to the customer; and
displaying the best monetary discount to the customer.

2. The method of claim 1, wherein the available promotions comprise a free gift promotion, a fixed price promotion, a percentage off promotion, and a dollar off promotion, and the priority set prioritizes the promotions in the order of free gift promotion, fixed price promotion, percentage off promotion, and dollar off promotion.

3. The method of claim 1, comprising determining the best monetary discount during customer checkout, and displaying the best monetary discount to the customer during checkout.

4. The method of claim 3, wherein checkout is in a retail store or on a website.

5. A system that is configured to determine the best monetary discount available to a customer, comprising:
a server that includes:
a promotion combinability matrix module that is configured to generate a promotion combinability matrix providing combination logic of a plurality of available promotions;
a priority set module that has stored in memory a priority set that identifies the priority in which the available promotions will be applied to the purchase; and
a determination module that is in communication with the promotion combinability matrix module and the priority set module, and that determines the best monetary discount that is available to the customer.

6. A computing system comprising:
one or more processors that can execute program instructions stored on one or more non-transitory computer-readable tangible storage devices to determine a best monetary discount available to a customer based on a plurality of available promotions;
one or more non-transitory computer-readable tangible storage devices that are accessible by the one or more processors and that store a promotion combinability matrix that identifies combination logic of the plurality of available promotions, and a priority set of the plurality of available promotions that identifies the priority in which the available promotions will be applied;
a user display device;
a user input device interfaced with the user display device;
program instructions stored on at least one of the one or more non-transitory computer-readable tangible storage devices which, when the program instructions are executed by the one or more processors, determines the best monetary discount available to the customer based on a purchase selection made by the customer through the user input device; and
displaying the best monetary discount on the user display device.

7. The computing system of claim 6, wherein the user display device is located in a retail store, or on the customer's personal computer, laptop, tablet or mobile phone.
